(19) United States
(12) Patent Application Publication
(10) Pub. No.: US 2016/0242391 A1
(43) Pub. Date: Aug. 25, 2016

(54) PET TOY WITH MULTI-FUNCTION MODULES

(71) Applicant: The KONG Company, LLC, Golden, CO (US)

(72) Inventors: John James Stone, Golden, CO (US); Dominic Mak, Mongkok (HK)

(21) Appl. No.: 14/927,874

(22) Filed: Oct. 30, 2015

Related U.S. Application Data
(60) Provisional application No. 62/150,906, filed on Apr. 22, 2015.
(60) Provisional application No. 62/119,348, filed on Feb. 23, 2015.

(51) Int. Cl. A01K 15/02

(52) U.S. Cl. CPC A01K 15/025

(57) ABSTRACT

A device of the invention includes a plurality of modules interconnected by ribs or connectors. A module includes an inner layer or shell; an outer layer or shell; and a noise making element. One of the noise making elements may be an interior sleeve or center layer secured between the inner and outer shells of a selected module. When the outer shell is deflected or compressed by contact, the interior sleeve is also deflected thereby producing sound. Another noise making element may include a squeaker supported within an interior chamber of a selected module. Different combinations of modules can be provided in which the modules may be of different shapes and sizes, as well as how the modules are geometrically spaced from one another by the ribs. The module combinations may also differ in the type and number of noise making elements adopted.

### CROSS-REFERENCE TO RELATED APPLICATIONS

This application claims priority under 35 U.S.C. §119(e) to U.S. Provisional Patent Application Ser. No. 62/150,906 filed Apr. 22, 2015 and U.S. Provisional Patent Application Ser. No. 62/119,348 filed Feb. 23, 2015, which are each incorporated herein in their entirety by reference.

### FIELD OF THE INVENTION

The invention relates to pet toys, and more particularly, to a pet toy having modules each constructed with multiple layers resulting in a pet toy with diverse responsive features when an animal interacts with the toy.

### BACKGROUND OF THE INVENTION

Due to the increased commercialization of pet products and particularly pet toys, there are now a wide range of commercially available pet toys with distinct functions. Pet toys can be made from many different types of materials along with a nearly limitless number of shapes and colors.

One general category of pet toys is those made of a flexible or elastomeric material, such as rubber. These toys, if made from quality materials, can withstand the biting action of an animal, and can keep an animal occupied for extended periods of time. It is known to place treats in these types of toys to increase the interaction of the animal with the toy. A sound emitting device, often referred to as a “squeaker”, is also known to be placed inside the toy to further stimulate the animal. Many rubber pet toys are made of a single layer of poor quality rubber material. An animal may therefore chew through and destroy the pet toy in a relatively short period of time.

Another general category of pet toys are those which may generally be referred to as “plush” toys. These types of toys are made from different types of cloth or fabric, and may also include material woven into strands, such as nylon rope. The plush toy is typically stuffed with a fibrous material, such as polyester stuffing, to provide the toy with an increased thickness or bulk that enables the animal to chew on the toy. Because the fibrous material is typically not strong enough to prevent the teeth of the animal from fully penetrating the outer cloth or fabric covering, plush toys are prone to being easily destroyed by the animal simply chewing through the outer covering. Plush toys may also include squeakers to further stimulate the animal.

Whether a pet toy is made from a flexible/elastomeric material or is a plush toy, the pet toys are typically made from one primary layer which defines the dominant characteristic of the pet toy in terms of its responsiveness to being chewed or otherwise played with. For example, a rubber toy with a single layer will typically deform in a uniform manner once it is chewed, and the pet toy will otherwise respond to activation by the animal in a uniform or consistent manner. If a squeaker is incorporated within the pet toy, the activation of the squeaker can also be generally defined as being uniformly responsive to activation by the animal chewing on the toy to generate sound. For plush toys, the reaction or response can also be generally characterized as being uniform or consistent, considering the toys are typically made from a single layer of material and are stuffed with a single type of material.

Considering the common forms of construction for many types of pet toys, there is a need to provide a pet toy with multiple responsive features which may help to entertain an animal longer. There is also a need to provide a pet toy that is robust enough to withstand the prolonged biting action of an animal, but is relatively simple in construction and therefore can be produced at a reasonable cost. There is also a need to provide a pet toy that has multiple responsive features that do not fall within the same general category of pet toys, which may further enhance the entertainment value of the toy for an animal.

The invention described herein overcomes many limitations in the prior art, yet incorporates a resilient, stable construction to withstand damage from prolonged biting and chewing from an animal. The invention provides multiple sources of stimulation for an animal, yet the pet toy is relatively simple in construction.

### SUMMARY OF THE INVENTION

The invention includes a pet toy having a plurality of modules with distinct construction characteristics enabling the toy to provide diverse responses when an animal interacts with the pet toy. More specifically, each of the modules include a selected multiple layered construction so that the modules may generate a desired response when contacted by the animal.

According to a preferred embodiment, the pet toy includes an outer shell or cover, an inner shell or inner piece, and selected elements to generate sound when the pet toy is deformed. One sound generating element may include a layer of PET placed between the inner and outer shells. According to the invention, this PET layer can produce a crackling or crinkling sound. Another sound generating element may include a “squeaker”. The term “squeaker” as used herein means a device that produces sound when air passes through it. A squeaker typically includes a thin piece of material or reed that vibrates when sound passes through the device thus generating the sound.

In one preferred embodiment, the modules may include constructions such that when one module is squeezed or deformed it produces the crackling or crinkling sound. A second module may produce a squeaking sound by a squeaker. Another module may produce another squeaking sound that is distinct from the second module. One module may have a different elastomeric characteristic from another module, which may be selected by changing the thickness or type of material used for the inner shell or inner part of a selected module.

Preferably, both the inner and outer shells are made from a flexible and elastomeric material that allows the modules to elastically deform in response to pressure applied to the modules, such as the biting or squeezing action of an animal. The modules will ultimately spring back to their original un-deformed shape due to the elastomeric nature of the material used.

A plurality of modules are separated from one another and are laterally disposed in a desired configuration. In one embodiment, the modules are linearly spaced from one another. In another embodiment, the modules may be grouped together forming a triangular configuration. In another embodiment, the modules may be spaced from one another forming an irregular curved configuration. In each of the embodiments the modules are connected to one another by ribs or spacers, and the geometrical arrangement of the ribs determines how the modules are spaced from one another.

The provision of multiple modules allows an animal to selectively activate a response from the modules. For example, one animal may prefer to interact with a module that produces the crackly sound while another animal may prefer to interact with a module that produces a squeaking sound. Alternatively, an animal may be more attracted to the pet toy of the invention because there are multiple responses generated when the animal interacts with all of the modules. Regardless of the particular motivation or desires of any one animal, the pet toy of the invention provides more opportunities for an animal to achieve longer lasting and more intense interactions with the pet toy because of the modules that generate distinct responses when contacted by the animal.

Because the pet toy has multiple layers, the overall strength of the pet toy may be enhanced because the thickness of the toy is greater as compared to single layer pet toys. Additionally, because there is more than one shell or layer, this provides the pet toy designer with multiple options for creating specific characteristics as to how the pet toy deflects or deforms in response to exterior pressure. For example, it may be desired to provide a very durable, tough pet toy in which the inner and outer shells are made from high-quality rubber which is quite resilient to the biting action of an animal. In yet another example, it may be desired to provide a softer exterior surface with a more robust or strong interior shell so that there is a discernible differential in how the pet toy feels to the animal. Similarly, one or more of the modules may include ribs to alter the response of the module to exterior pressure.

According to one preferred embodiment, the inner and outer shells may be made from thermoplastic rubber (TPR). Under one general description or definition of TPR, it may be considered a thermoplastic rubber that has melting and/or molding properties of plastic while still maintaining some advantageous flexible and elastomeric properties of rubber. One distinguishing characteristic of TPR as compared to a thermoplastic elastomer or (TPE) is that a TPR may have a “shiny” or reflective side. In this regard, having one surface that is reflective may enhance the visual characteristics of the toy.

Different materials may be used to form the inner and outer shells. Preferably, the outer shell is formed of a material that is durable and of a quality to prevent teeth of an animal from penetrating the outer shell and damaging the inner shell and the intermediate layer. The outer shell may also be denser or thicker than the inner shell to provide added strength to the pet toy or to limit damage to the pet toy by the teeth of the animal.

The interior sleeve or center layer may be made from polyethylene terephthalate (PET). PET is a plastic moldable resin and is commonly used in packaging for both food and non-food items. PET is one example of a material that can produce a crackly/crinkly noise associated with the interior sleeve, and can rebound or recoil from being compressed due to its flexible and resilient characteristics.

The specific shape of the pet toy may take many forms. Considering that the inner and outer shells may be made in a molding process, current molding technology therefore permits the molding of complex shapes so that the pet toy may take many different forms.

Although preferred embodiments disclosed herein adopt a two or three layered configuration with the inner and outer shells along with the interior or center sleeve, it is also specifically contemplated that the pet toy may incorporate additional layers or shells which may provide some additional strength and/or resilience for the toy.

According to one general method of manufacture, the pet toy may include inner and outer shells that are molded in half or bisected sections. Assembly of the half/bisected sections is achieved along matching and opposing side edges of the half sections. In order to stabilize the connection between the half sections and/or the connections between inner and outer shells of a module, as well as to increase the strength and durability of the connections, a “tongue and groove” configuration may be adopted in which one joining or abutting surface/edge includes a groove or recess, and the matching edge of the other abutting surface/edge includes a tongue or flange received in the groove/recess. While the inner and outer half sections are joined to one another, the inner or center layer is not joined to either the upper and lower sections. The inner or center layer is allowed to remain unattached in a gap or space between the inner and outer shells so that the inner/center layer is able to better generate a crackling/crinkling sound by being able to move or shift in the gap or space in response to deflection or compression of the corresponding module.

To accommodate airflow in the gap or space between the inner and outer shells, one or more air or vent holes may be provided in the outer shell. In this regard, movement of air into and out of the gap between the inner and outer shells allows the center/inner layer to more easily deflect in response to contact since the gap/space itself is more easily deflected as compared to if the gap/space was sealed between the inner and outer shells.

In one embodiment, the first and second materials are made from one or more types of TPR material, and the inner or center layer is made from PET.

Considering the above features and characteristics of the invention, in one aspect of the invention, it may be considered a pet toy comprising: (i) a plurality of modules connected to one another by at least one rib; (ii) each module having an outer shell and an inner shell; (iii) at least one of the modules having a center layer disposed between the inner and outer shells, the center layer being made of a sound producing material activated when the center layer is displaced in response to deformation of the outer shell; and (iv) at least one of the modules having a noise making device with a first end supported by said outer shell and a second end extending within an interior chamber of the corresponding module.

According to other features of the invention in accordance with this first aspect, the invention may further include the modules and the at least one rib are molded in respective half sections. In one embodiment, the half sections are each substantially symmetrical about an axis. Additionally or alternatively, the material of the outer shell may have a different rigidity or flexibility as compared to the material of the inner shell. In one embodiment, the inner and outer shells have different thicknesses. In another embodiment, the inner and outer shells are made of materials with different densities.

The half sections are joined to one another to assemble said pet toy. Optionally, one half section of an outer shell includes a peripheral flange and a groove or protrusion formed with said peripheral flange. One half section of a corresponding inner shell includes a groove or protrusion for mating with said groove or protrusion of said outer shell. In another embodiment, the respective half sections are glued or welded together to assemble the pet toy.

The toy may include any number of modules. In one embodiment, the plurality of modules include at least three modules disposed in a linear configuration. In another embodiment, the plurality of modules include at least three modules disposed in a triangular configuration. In still another embodiment, the plurality of modules include at least three modules disposed in a curved configuration. Optionally, each of the modules may be of substantially the same size and shape. In one embodiment, at least one module is smaller than the other modules. In another embodiment, the modules are substantially spherical in shape.

In one embodiment, the noise making devices of a first module and a second module comprise squeakers. The squeaker of the first module may be of a different type or size, or produce a different sound, than the squeaker of the second module.

The rib may include a pair of ribs disposed on opposite sides of the modules thereby providing connection for both sides of each module. In one embodiment, the rib includes a pair of ribs disposed for connection at substantial midpoints along respective connected modules.

According to another aspect of the invention, it may be considered a method of stimulating an animal for play with a pet toy, the method comprising: (a) providing a pet toy having: (i) a plurality of modules connected to one another by at least one rib; (ii) each module having an outer shell and an inner shell; (iii) at least one of the modules having a center layer disposed between the inner and outer shells, the center layer being made of a sound producing material activated when the center layer is displaced in response to deformation of the outer shell; and (iv) at least one of the modules having a noise making device with a first end supported by said outer shell, and a second end extending within an interior chamber of the corresponding module; (b) giving the pet toy to an animal for play; and (c) wherein the animal plays with the toy, compressing or deforming the outer shell. The play of the animal may include biting the pet toy. The inner and outer shells provide resilient and elastomeric responses to the biting action and other deformation of the outer shell caused by the animal. In one embodiment, the center layer creates a first sound and the noise making device makes creates a second different sound.

### BRIEF DESCRIPTION OF THE DRAWINGS

FIG. 1 is a perspective view of the pet toy in a first embodiment with a plurality of modules in a generally linear configuration;

FIG. 2 is a bottom plan view of the embodiment of FIG. 1;

FIG. 3 is a side elevation view of the embodiment of FIG. 1;

FIG. 4 is a cross-section of FIG. 3;

FIG. 5 is a perspective view of an upper half or upper portion of the pet toy of FIG. 1 showing interior details thereof;

FIG. 6 is a perspective view of a lower half or lower portion of the pet toy of FIG. 1 showing interior details thereof;

FIG. 7 is a perspective view of an upper portion of an inner part of one embodiment showing the particular shape thereof; a lower portion being substantially identical to the upper portion according to the first embodiment;

FIG. 8 is a perspective view of an example noisemaking device that may be used with the invention;

FIG. 9 is a bottom perspective view of the invention in a second preferred embodiment comprising a plurality of modules in a generally triangular configuration;

FIG. 10 is a top plan view of the embodiment of FIG. 9;

FIG. 11 is a side elevation view of the embodiment of FIG. 9;

FIG. 12 is a perspective view of an upper half or upper portion of the pet toy of FIG. 9 showing interior details thereof;

FIG. 13 is a perspective view of a lower half or lower portion of the pet toy of FIG. 9 showing interior details thereof;

FIG. 14 is a cross-section of FIG. 11;

FIG. 15 is a top perspective view of the invention in a third preferred embodiment including a plurality of modules in a generally curved configuration;

FIG. 16 is a bottom plan view of the embodiment of FIG. 15;

FIG. 17 is a side elevation view of the embodiment of FIG. 15; and

FIG. 18 is a cross-section of FIG. 17 with the plane of the cross-section intersecting two of the modules.

### DETAILED DESCRIPTION

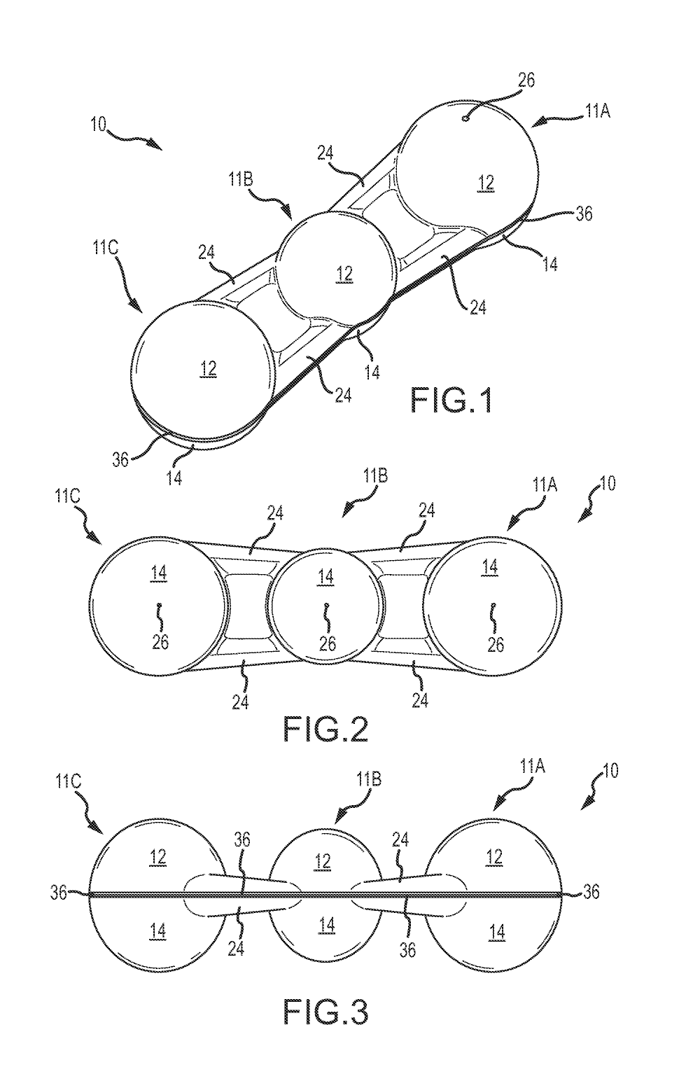

The pet toy 10 of the invention is illustrated in a first preferred embodiment at FIGS. 1-6. The particular construction of the pet toy 10 in this first embodiment shows a multi-module configuration of three modules 11 interconnected to one another by corresponding ribs or connectors 24. One of the three modules 11A has a three layered construction with corresponding groups of half sections. The other two of the three modules 11B, 11C have a two layered construction with corresponding groups of half sections and a noise making instrument secured to the modules. Specifically, FIG. 1 shows the pet toy 10 as having three modules spaced from one another in a generally straight or linear connection in which there is a center module 11B and two opposing end modules 11A, 11C. Accordingly, there are two separate ribs or connectors 24 used to interconnect the modules 11. As also shown, the ribs may be provided in pairs in which each pair of ribs is disposed on opposite sides of the modules thereby providing a more stable or robust interconnection between the modules. Further, the pairs of ribs are shown as being disposed along midpoints of the respective connected modules; however, it shall be understood that the ribs can be modified in their location to best interconnect modules that may be of different sizes and shapes. Accordingly, in another aspect of the invention, it is contemplated that the modules in fact may have different sizes and shapes. For example, in one embodiment, the center module 11B has a size that is different than at least one of the two other modules. Optionally, the center module 11B is smaller than at least module 11A.

The module 11A with the three layers more specifically includes an outer layer or shell with upper and lower half sections 12 and 14, an inner layer or shell with upper and lower half sections 16 and 18, and an inner or center layer 20 placed in the gaps between the inner and outer shells. Optionally, interior supporting ribs or protrusions may be incorporated on exterior surfaces of the inner sections 16, 18 or on the interior surfaces of the outer sections 12, 14. The ribs may be arranged to improve the shape memory of the module 11A or alter the flexibility of the module. In this manner, the ribs may improve the ability of the module 11A to return to an un-deformed state after biting by an animal. The protrusions may provide a predetermined amount of separation between the inner section 16, 18 and the outer section 12, 14. Additionally, the sound produced by the center layer 20 may be altered as the layer contacts the protrusions.

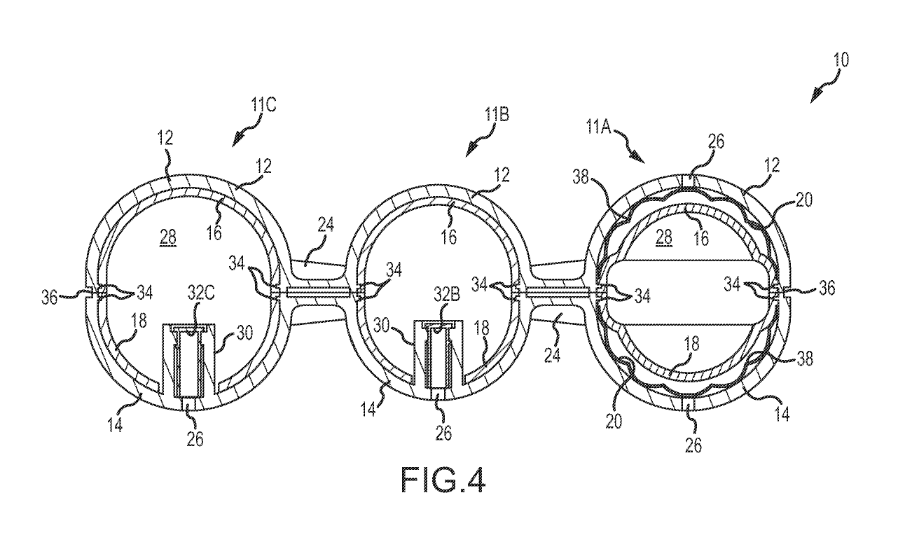

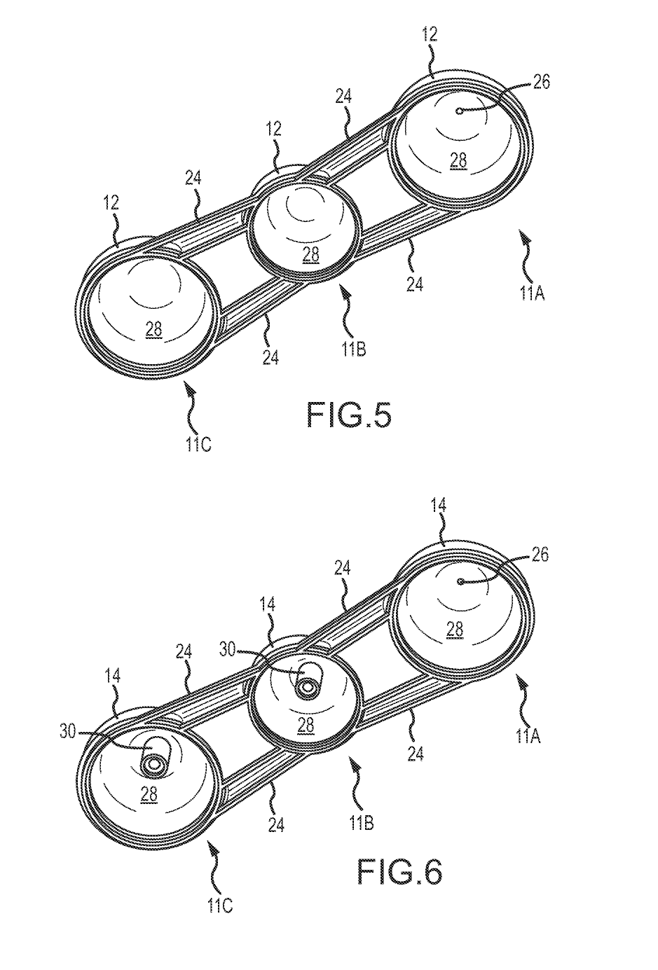

These layers or shells are provided in the half sections that are joined to one another along facing edges or joining surfaces as best shown in FIGS. 5 and 6. The inner layer 20 has respective upper and lower half sections as best seen in FIG. 4 that are not connected to one another. The upper and lower half section of the inner layer 20 may be substantially identical. Accordingly, each half section of the inner layer 20 may independently move or displace within the corresponding gap located between the outer shell half sections 12, 14 and inner shell half sections 16, 18. Openings 26 are provided on both of the half sections 12, 14 that allows air to pass into and out of the gaps between the inner 16, 18 and outer 12, 14 shells. This dual vented configuration allows the outer shells to more easily collapse against the corresponding inner layers 20 to produce sound as the inner layer is also deflected or otherwise undergoes a change in shape.

The outer section 12, 14 may be formed of a material that is translucent or substantially transparent. The material of the inner lay 20 may thus reflect light at multiple angles from the tiers 38 through the outer sections 12, 14 as an animal plays with the toy.

The other two modules 11B, 11C are illustrated as having two layered constructions with corresponding groups of half sections to include the outer shell half sections 12, 14 and the inner shell half sections 16, 18. Interior surfaces 28 of the inner section 16, 18 define an interior space or chamber within the modules 11B, 11C. These other two modules are illustrated as each further having a noisemaking device such as a squeaker 32 located within their chambers. As seen in FIG. 4, an interior mount 30 extends into the chamber of each module. The mount 30 has a generally cylindrical shape with a bore or opening that extends axially through the mount. An opening at the distal (or interior) end of the mount 30 connects to the bore. The squeaker 32 is secured within the bore of the interior mount 30 in a generally suspended or supported position within the chamber such that the squeaker is located in a protected position from contact by an animal. Another opening 26 in the outer shell 14 allows a pathway for air to pass through the squeaker 32 and to communicate with the interior chamber within the module. As a module changes in shape due to compression forces imposed upon it by an animal or owner, air is able to pass in and out of the interior chamber to produce sound by corresponding air movement through the squeaker. From this supported or suspended position, the squeaker 32 is able to pass air so that a consistent noise can be generated from the squeaker whenever the pet toy is squeezed or otherwise deformed.

As also shown in FIG. 4, the squeaker 32 is able to maintain a spaced and suspended relationship with the interior surface 28 of the corresponding module to more reliably generate sound as compared to if the squeaker was mounted in contact with the interior surface. If the squeaker was mounted against the interior surface, operation of the squeaker might become inhibited if compression of the toy resulted in blocking flow of air through the squeaker. Further, because the squeaker 32 is positioned within the mount 30, the biting action of an animal does not result in direct contact of the animal's mouth with the body of the squeaker.

Optionally, the mount 30 is flexibly connected to the outer section 14. The flexible nature of the connection between the mount 30 and outer section 14 allows the mount to collapse against the interior surface 28 of the module. In this manner, the interior surface 28 of the chamber will not cover the opening at the distal end of the mount 30 which would prevent the noise maker 32 from making noise. The noise making device 32 can also flex or bend along the point at which the mount 30 attaches to the outer section 14. As a consequence, in the event of excessive deformation of the module 11 resulting in contact of the interior surface 28 of the module chamber with the mount 30, the mount 30 can flex or bend to prevent damage to the noise making device.

In one embodiment, illustrated in FIG. 4, the mount 30 is formed by a portion of the lower half section 14. However, it will be appreciated that the mount may be arranged differently within the module. For example, in another embodiment, the mount 30 comprises two substantially equal half sections extending inwardly from each of the outer shell half sections 12, 14. Said another way, the mount 30 may be positioned proximate to the joining surface of the half sections 12, 14 and generally aligned with a plane formed by the joining line 36. Optionally, in one embodiment, the mount 30 is positioned proximate to a rib connector 24. In this way, the squeaker 32 within the mount 30 may be protected from damage caused by biting of the animal. Further, the rib 24 may prevent removal of the squeaker 32 from the mount by the animal. In another embodiment, a portion of the inner sections 16, 18 may wrap at least partially around the exterior of the mount 30. In this manner, the squeaker may be further protected from damage.

In one embodiment, also illustrated in FIG. 4, the mount 30 extends generally radially into the interior of the chamber. However, it will be appreciated that the mount may extend at an angle into the interior. Accordingly, in one embodiment, the mount 30 is not orthogonal to a line tangent to one of the half sections 12, 14. In another embodiment, the mount extends at an angle of approximately 45 degrees into the chamber. Because of the angle at which the mount 30 extends into the chamber, the distal end of the mount 30 is not parallel to the interior surface 28. As a consequence, deformation of the module 11 causing contact of the interior surface 28 with the mount 30 will not result in the interior surface 28 making flush contact with the opening in the distal end of the mount 30. Thus, the angular orientation of the mount 30 may prevent the interior surface 28 of the chamber from sealing the bore through the mount 30 if the interior surface 28 contacts the mount 30 as the module 11 is compressed by play of the animal. Accordingly, airflow will continue through the opening in the housing despite the deformation experienced along the sidewall. Alternatively, the mount 30 may be formed with a distal end formed at an angle that is not perpendicular to the cylindrical body. Optionally, a series of bumps may be formed on the distal end of the mount 30 to prevent the distal end from being completed obstructed by contact with the interior surface 28.

Although the mounts 30 of modules 11B, 11C are illustrated as being in substantially the same locations and orientations, it will be appreciated that the mount of each module may be located in different areas. In this manner, the toy 10 may make noises in more situations, or the squeakers may be non-uniformly activated. Further, the noise may come from two different directions which may enhance the interest of the animal and stimulate further play. Accordingly, in one embodiment, the openings 26 for the mounts 30 are located on different sides of the modules 11B, 11C. In one embodiment, the mounts 30 of modules 11B, 11C are not parallel. Optionally, the mounts of modules 11B, 11C are substantially perpendicular.

Each of the shells/layers has complementary shapes such that when the pet toy is assembled, the shells/layers remain in a nested or concentric configuration. Further, the shells/layers may have similar or different cross-sectional thicknesses to accommodate desired variances in elastomeric rebound in response to compression forces imposed upon the toy. Accordingly, it is contemplated that the inner 16, 18 and/or outer 12, 14 shells may be of different thicknesses to match a desired degree of deflection that occurs in response to a predetermined amount of compression force applied. Each module 11 may also have a different color. Similarly, the exterior surfaces of the modules may have different textures or include protrusions, depressions, grooves, or combinations thereof. Thus, the modules may provide different surfaces that are easier or more difficult for an animal to bite to stimulate additional play from the animal. In one embodiment, one module is substantially smooth and another module has a rough surface. In another embodiment, at least one module has a plurality of bumps or depressions. In still another embodiment, one of the modules has an exterior surface that is softer or more pliable than the other modules.

The inner and outer shells may be joined to one another along their corresponding joining surfaces by a mating or connection arrangement. In FIG. 4, the connecting arrangement resembles a “tongue in groove” connection 34 in which the upper half section of the outer shell 12 incorporates a tongue or extension, and the corresponding upper half section of inner shell 16 incorporates a groove or recess to receive the tongue/extension. This tongue and groove type connection may extend around the entire periphery of the joining surfaces. Alternatively, the tongue and groove connection may be incorporated only upon selected sections of portions of the joining surfaces. Similarly as illustrated, the lower half sections of the inner 18 and outer 14 shells, as shown, may also incorporate a desired mating or connection arrangement such as a “tongue in groove” connection 34.

The assembled inner and outer shell half sections may be joined along joining line or interface 36, as also shown in FIG. 4, by any suitable method. For example, in one embodiment, the half sections may be joined by heat welding, by an acceptable food grade adhesive, or combinations thereof. This joining line or interface 36 also extends across the connecting ribs 24 such that the corresponding upper and lower half sections can also be conveniently joined along a single and substantially planar connecting surface. Optionally, in one embodiment, the joining surfaces along the connection 34 include a protrusion of one of the outer portions 12, 14 that is retained by a recess or cavity of the other outer portion 14, 12. Accordingly, when the two outer portions 12, 14 are pressed together, the protrusion fits into the recess to interconnect the outer portions together. In this manner, protrusion and the recess may be used to form, or supplement, a joint between the assembled inner and outer shell half sections.

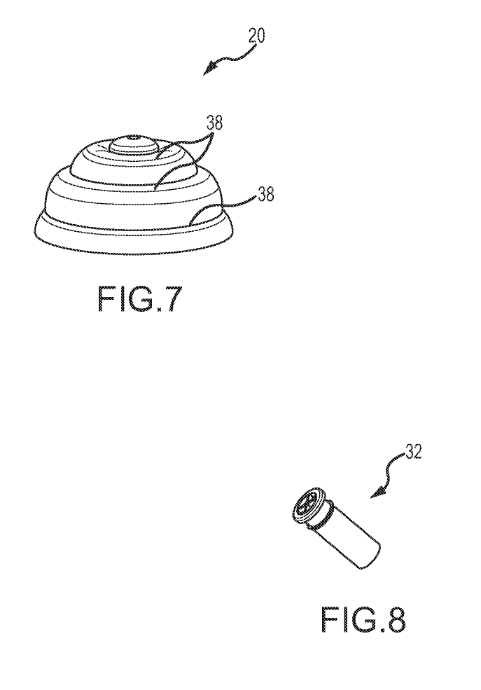

Referring to FIG. 7, one of the interior sleeves 20 is illustrated. As shown, the sleeve 20 has a multi-tiered shape as defined by separating lines or tiers 38. According to this shape, the sleeve is capable of collapsing along multiple planes or areas when the outer shell is deflected. The collapsing of the sleeve 20 generates a crackling or crinkling sound that may stimulate an animal. Further, because the sleeve is provided in the multi-tiered shape, it is capable of collapsing along different levels or areas so that deflection of the outer shell along various locations will still result in some type of collapse of the sleeve thereby producing a sound. Additionally or alternatively, ridges or bumps may be formed on the sleeve 20 to alter, or increase, the sound produced as the sleeve is bent or compressed between the inner 16, 18 and outer 12, 14 sections.

Referring now to FIG. 8, an embodiment of a noise making device 32 is shown. The noise making device 32 can be a conventional squeaker used in pet toys. The squeaker may include a noise producing element, such as a flexible reed (not shown). The reed is mounted in the squeaker in such a manner that as air flows around the reed, the reed vibrates and generates a noise. The noise making device 32 may be of any desired length or diameter. In one embodiment of the present invention, the noise making devices 32 in each module produce different sounds. For example, in one embodiment, the noise maker 32B in module 11B has at least one of a different length and diameter than the noise maker 32C in module 11C. Optionally, reeds of different materials or lengths may be used to produce different sounds. Other noise making devices can be used, and based on the space available in the hollow interior 26, the housing 30 can be sized and shaped to accommodate the particular noise making device chosen.

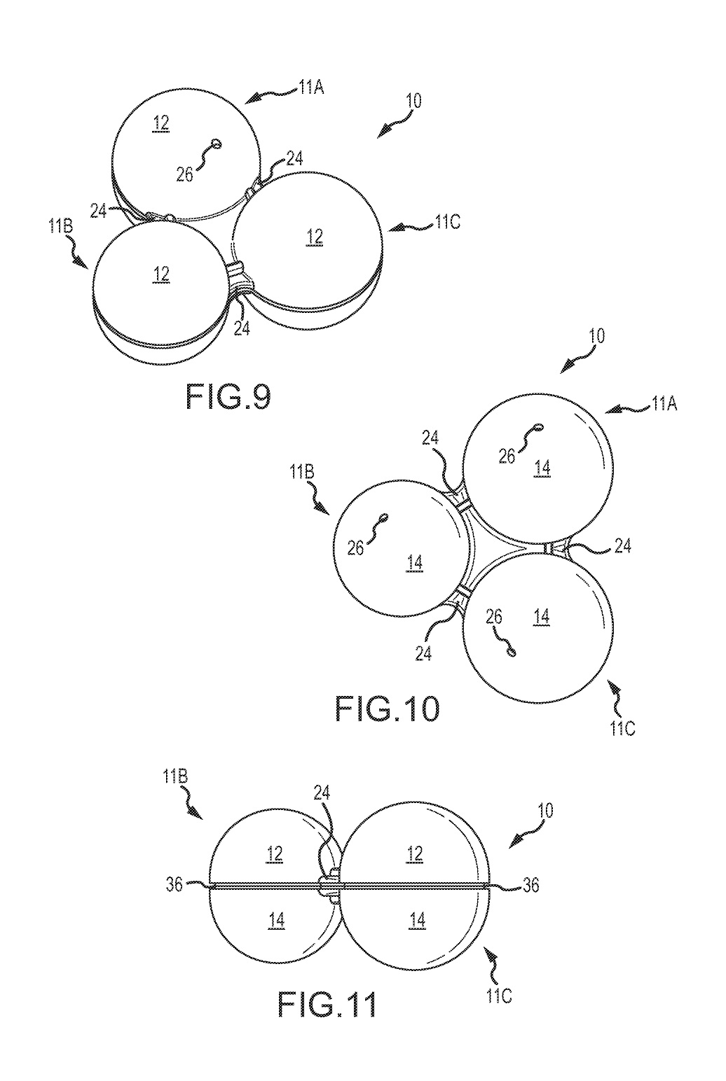

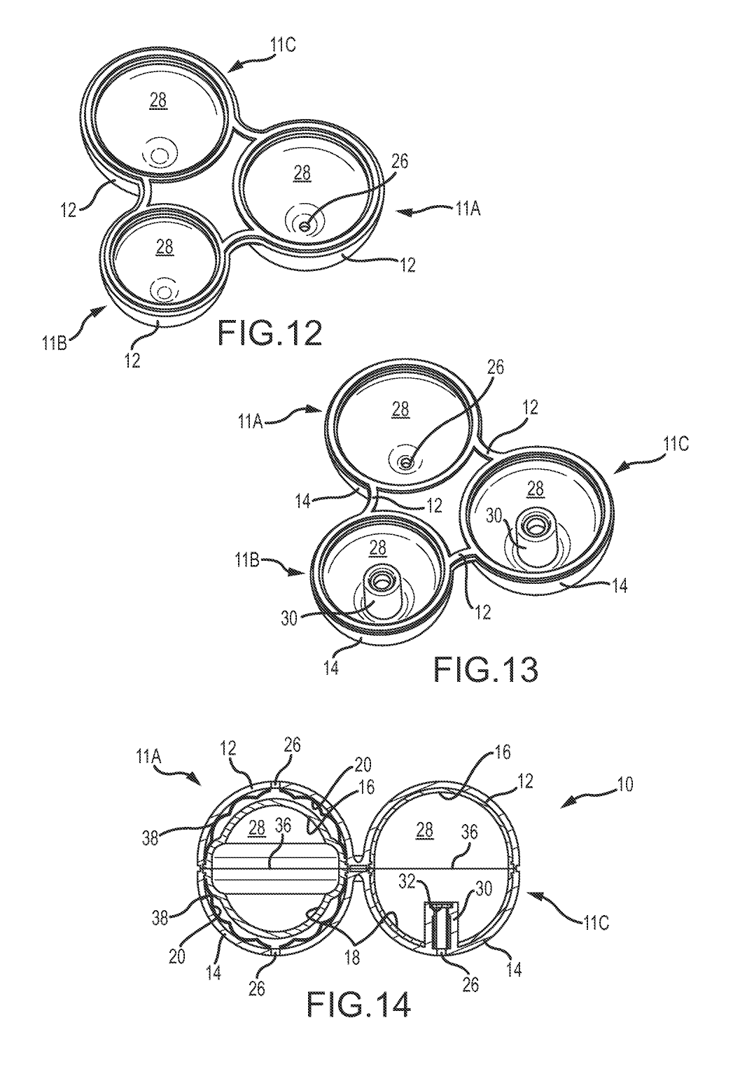

Referring to FIGS. 9-14, another embodiment of a toy 10 is illustrated in which the modules 11 are placed in a generally triangular configuration by three ribs 24. This embodiment also adopts a construction in which at least one of the modules has a three layered construction, and at least one of the other two modules has a two layered construction that incorporates a noisemaking device such as a squeaker. The same reference numerals used in this embodiment correspond to the same structure described with respect to the first embodiment. Two of the modules 11A, 11C have a similar size and shape and the third module 11B has a similar shape but is of a smaller size. More specifically, two of the modules 11A, 11C are shown as larger spherical elements and the third module 11B is shown as a smaller spherical element. As mentioned, it is contemplated that the modules may be of different sizes and/or shapes.

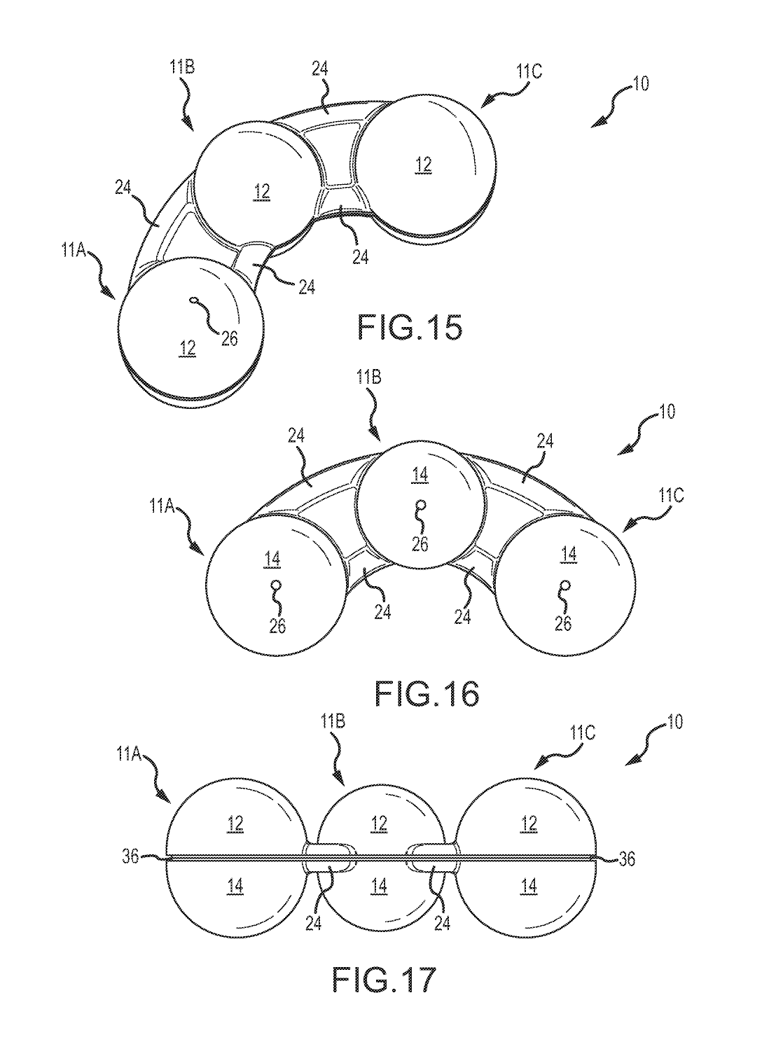

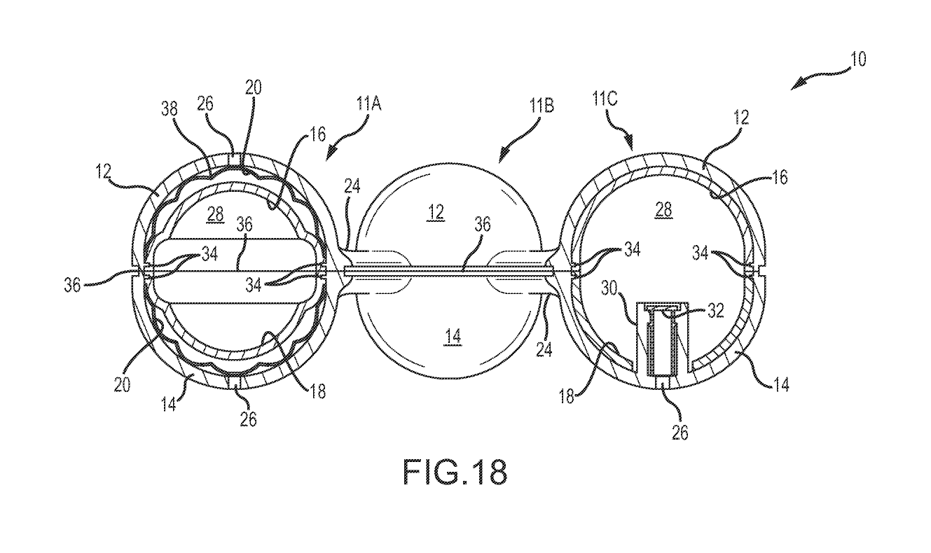

Referring to FIGS. 15-18, another embodiment is illustrated in which the modules 11 are placed in a curved configuration as determined by the arrangement of the ribs 24. This embodiment, as seen in FIG. 18, also adopts a configuration in which at least one of the modules, module 11A, has a three layered construction and at least one of the other two modules, for example, module 11C, has a two layered construction that incorporates a noisemaking device such as a squeaker 32. Again, the same reference numerals used in this embodiment correspond to the same structure described with respect to the first embodiment. The modules in this embodiment are shown as three similarly sized spherical elements with two pairs of ribs 24 that interconnect the modules. However, it will be appreciated that one of the modules may be of a different size. For example, in one embodiment, the middle or medial module 11B is a different size than the other modules 11A, 11C. In one embodiment, module 11B is smaller than at least one of the other module.

The preferred embodiments of the invention illustrate a number of different general shapes or configurations of combined modules, and in which multi-layers or concentric shells are used in selected ones of the modules. A squeaker may be held in and supported in a protected position within the interior chamber of the modules. The half molded sections for the inner and outer shells simplify construction.

Although the invention is described in particular detail with respect to preferred embodiments and accompanying drawings, it shall be understood that the invention is not specifically limited to the preferred embodiments and is rather encompassed by the scope of the claims appended hereto.

What is claimed is:

1. A pet toy comprising:
a plurality of modules connected to one another by at least one rib;
each module having an outer shell and an inner shell;
at least one of the modules having a center layer disposed between the inner and outer shells, the center layer being made of a sound producing material activated when the center layer is displaced in response to deformation of the outer shell; and
at least one of the modules having a noise making device with a first end supported by said outer shell, and a second end extending within an interior chamber of the corresponding module.

2. A pet toy, as claimed in claim 1, wherein:
said modules and said at least one rib are molded in respective half sections and are joined to one another to assemble said pet toy.

3. A pet toy, as claimed in claim 1, wherein:
said half sections are each substantially symmetrical about an axis.

4. A pet toy, as claimed in claim 1, wherein:
one half section of an outer shell includes a peripheral flange and a groove or protrusion formed with said peripheral flange; and
one half section of a corresponding inner shell includes a groove or protrusion for mating with said groove or protrusion of said outer shell.

5. A pet toy, as claimed in claim 1, wherein:
said plurality of modules include at least three modules disposed in a linear configuration.

6. A pet toy, as claimed in claim 1, wherein:
said plurality of modules include at least three modules disposed in a triangular configuration.

7. A pet toy, as claimed in claim 1, wherein:
said plurality of modules include at least three modules disposed in a curved configuration.

8. A pet toy, as claimed in claim 1, wherein material of the outer shell has a different rigidity or flexibility as compared to the material of the inner shell.

9. A pet toy, as claimed in claim 1, wherein the inner and outer shells have different thicknesses.

10. A pet toy, as claimed in claim 1, wherein the rib includes a pair of ribs disposed on opposite sides of the modules thereby providing connection for both said sides thereof.

11. A pet toy, as claimed in claim 1, wherein the rib includes a pair of ribs disposed for connection at substantial midpoints along respective connected modules.

12. A pet toy, as claimed in claim 1, wherein the modules are substantially spherical in shape.

13. A pet toy, as claimed in claim 1, wherein at least one of the modules includes a vent opening to allow air to pass through the module in which the vent opening is installed.

14. A pet toy comprising:
a plurality of modules connected to one another by at least one rib;
each module having an outer cover;
at least one of the modules having an interior sleeve made of a sound producing material that is activated when the interior sleeve is displaced in response to deformation of the outer cover; and
at least one of the modules having a squeaker with a first end supported by said outer shell, and a second end extending within an interior chamber of the corresponding module.

15. A pet toy, as claimed in claim 14, wherein:
said outer cover for each module includes two half sections that are arranged substantially symmetrical about an axis.

16. A pet toy, as claimed in claim 14, wherein:
said plurality of modules include at least three modules disposed in a linear configuration.

17. A pet toy, as claimed in claim 14, wherein:
said plurality of modules include at least three modules disposed in a triangular configuration.

18. A pet toy, as claimed in claim 14, wherein:
said plurality of modules include at least three modules disposed in a curved configuration.

19. A pet toy, as claimed in claim 14, wherein a material of the outer cover has a different rigidity or flexibility as compared to a material of an inner shell of a corresponding module.

20. A pet toy, as claimed in claim 14, wherein the rib includes a pair of ribs disposed on opposite sides of the modules thereby providing connection for both said sides thereof.

21. A pet toy, as claimed in claim 14, wherein at least one of the modules includes a vent opening to allow air to pass through the module in which the vent opening is installed.

22. A method of stimulating an animal for play with a pet toy, the method comprising:
providing a pet toy having: (i) a plurality of modules connected to one another by at least one rib; (ii) each module having an outer shell and an inner shell; (iii) at least one of the modules having a center layer disposed between the inner and outer shells, the center layer being made of a sound producing material activated when the center layer is displaced in response to deformation of the outer shell; and (iv) at least one of the modules having a noise making device with a first end supported by said outer shell, and a second end extending within an interior chamber of the corresponding module;
giving the pet toy to an animal for play; and
wherein the animal plays with the toy including biting the pet toy in which the inner and outer shells provide resilient and elastomeric responses to the biting action of the animal, the center layer creates a first sound, and the noise making device makes creates a second different sound.
